(19) United States
(12) Patent Application Publication
(10) Pub. No.: US 2011/0249889 A1
(43) Pub. Date: Oct. 13, 2011

(54) STEREOSCOPIC IMAGE PAIR ALIGNMENT APPARATUS, SYSTEMS AND METHODS

(76) Inventors: Sreenivas Kothandaraman, Richardson, TX (US); Wei Hong, Sunnyvale, CA (US); Aziz Batur, Dallas, TX (US)

(21) Appl. No.: 13/082,354

(22) Filed: Apr. 7, 2011

Related U.S. Application Data
(60) Provisional application No. 61/322,194, filed on Apr. 8, 2010.

(51) Int. Cl. G06K 9/00

(52) U.S. Cl. 382/154

(57) ABSTRACT

Apparatus, systems, and methods disclosed herein operate to produce an image alignment shift vector used to shift left and right image portions of a stereoscopic image with respect to each other in order to reduce or eliminate undesirable horizontal and vertical disparity components. Vertical and horizontal projections of luminance value aggregations from selected left and right image pixel blocks are correlated to derive vertical and horizontal components of a disparity vector corresponding to each left/right pixel block pair. Disparity vectors corresponding to multiple image blocks are algebraically combined to yield the image alignment shift vector. The left and/or right images are then shifted in proportion to the magnitude of the image alignment shift vector at an angle corresponding to that of the image alignment shift vector.

### PRIORITY CLAIM

This application claims the benefit of priority under 35 U.S.C. §119(e) to U.S. Provisional Patent Application Ser. No. 61/322,194 titled “Auto-alignment of Stereoscopic Image-pairs Using Boundary Signals,” filed on Apr. 8, 2010 and incorporated herein by reference in its entirety.

### TECHNICAL FIELD

Embodiments described herein relate to apparatus and methods associated with imaging technology, including structures and methods associated with stereoscopic image pair alignment.

### BACKGROUND INFORMATION

As a three-dimensional pictures and movies become increasingly popular, methods of stereoscopic imaging are being refined to create images of increasing fidelity. One area of interest in this regard is that of left and right image alignment.

Three-dimensional effects are created by slight differences between left and right images resulting from slightly different angular views from the left and right eyes. Left and right cameras used in stereoscopic imaging are typically mounted with a separation approximating the distance between left and right eyes in order to record images at angles of view simulating those of human vision.

However, inaccuracies associated with stereoscopic imaging result in horizontal and vertical misalignment referred to as horizontal and vertical disparity, respectively. Although proper amounts of horizontal disparity are responsible for the three-dimensional effect, stereoscopic imaging from cameras typically results in excessive or insufficient horizontal disparity. Unnatural horizontal disparity results from the cameras' fixed lenses, which are unable to rotate about the horizontal plane in accordance with the distance to the focal plane as do human eyes. Vertical disparity may result from vertical misalignment between right and left imaging devices.

Vertical disparity and unnatural amounts of horizontal disparity create visual crosstalk and may introduce visual artifacts and viewing discomfort. Consequently, stereoscopic imaging may be improved by adjusting the positions of left and/or right images with respect to each other in order to remove the vertical disparity and the unnatural amounts of horizontal disparity. However, doing so first requires estimating the amounts of disparity to correct for. Estimating disparity, in turn, requires the identification of the positions of common features within the left and right images.

Known methods of estimating horizontal and vertical disparity include block-based pixel matching and feature point identification. These methods may be computationally intensive and difficult to implement in real time for video.

### BRIEF DESCRIPTION OF THE DRAWINGS

FIG. 1 is a diagram of a stereoscopic image pair divided into blocks of pixels according to various example embodiments of the invention.

FIG. 2 is a block diagram of a stereoscopic image alignment system according to various example embodiments.

FIG. 3 is a schematic diagram illustrating an example pixel block and an associated boundary table creation mechanism according to various example embodiments.

FIG. 4 is a diagram illustrating left and right image block boundary table alignment according to various example embodiments.

FIG. 5 is a schematic diagram illustrating multiple pixel blocks and corresponding vertical and horizontal boundary tables associated with an image frame according to various example embodiments.

FIG. 6 is a schematic diagram showing image block disparity vectors and image alignment within left and right image frames according to various example embodiments.

FIGS. 7A, 7B, 7C, 7D and 7E are flow diagrams illustrating several example methods according to the invention.

### SUMMARY OF THE INVENTION

Embodiments and methods herein operate to produce an image alignment shift vector used to shift left and right image portions of a stereoscopic image with respect to each other in order to reduce or eliminate undesirable horizontal and vertical disparity components.

Pixel luminance values associated with blocks of pixels selected from left and right images are aggregated by projecting rows of luminance values from a selected pixel block onto a vertical axis and columns of luminance values from the selected block onto a horizontal axis. The resulting vertical axial aggregations of pixel luminance values projected from a left image pixel block is correlated to the vertical axial aggregations of pixel luminance values projected from a corresponding right image pixel block. The left and right pixel block vertical axial aggregations are shifted with respect to each other by a number of pixel row positions resulting in best-fit correlation between the vertical axial aggregations of pixel luminance values from the left and right image pixel blocks. A resulting pixel row shift index value corresponding to the best-fit correlation is taken as the vertical component of a disparity vector associated with the selected pixel block.

Likewise, the resulting horizontal axial aggregations of pixel luminance values projected from the left image pixel block are correlated to the horizontal axial aggregations of pixel luminance values projected from the corresponding right image pixel block. The left and right block horizontal axial aggregations are then shifted with respect to each other by a number of pixel column positions resulting in a best-fit correlation between the horizontal axial aggregations of pixel luminance values from the left and right image pixel blocks. A resulting pixel column shift index value corresponding to the best-fit correlation is taken as the horizontal component of the disparity vector.

Disparity vectors associated with multiple pixel blocks are algebraically combined to create an image alignment shift vector. The left and right images are then shifted with respect to each other within their corresponding image frames in proportion to the image alignment shift vector.

### DETAILED DESCRIPTION

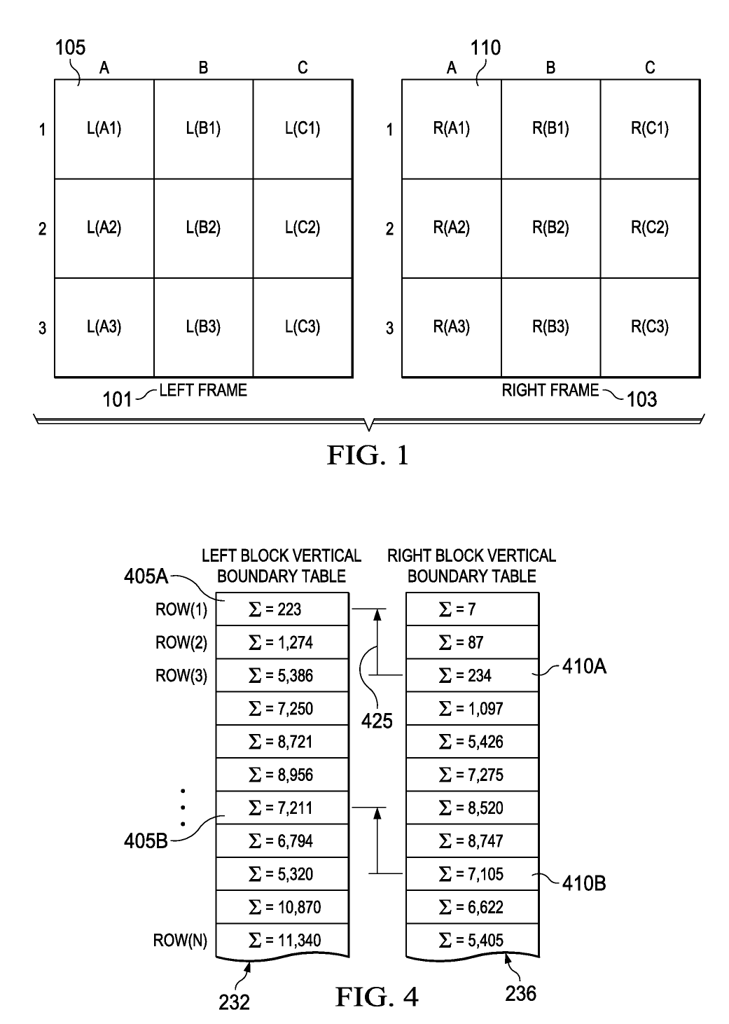

FIG. 1 is a diagram of a stereoscopic image pair divided into blocks of pixels according to various example embodiments of the invention. Each of the left frame 101 and the right frame 103 is divided into a number, shape, and size of pixel blocks that may differ from one embodiment to another. In some embodiments, a pixel block maybe identified for the right frame of the same shape, size, and position of each pixel block identified in the left frame. For example, left frame pixel block 105 is of the same shape, size, and position as right frame pixel block 110.

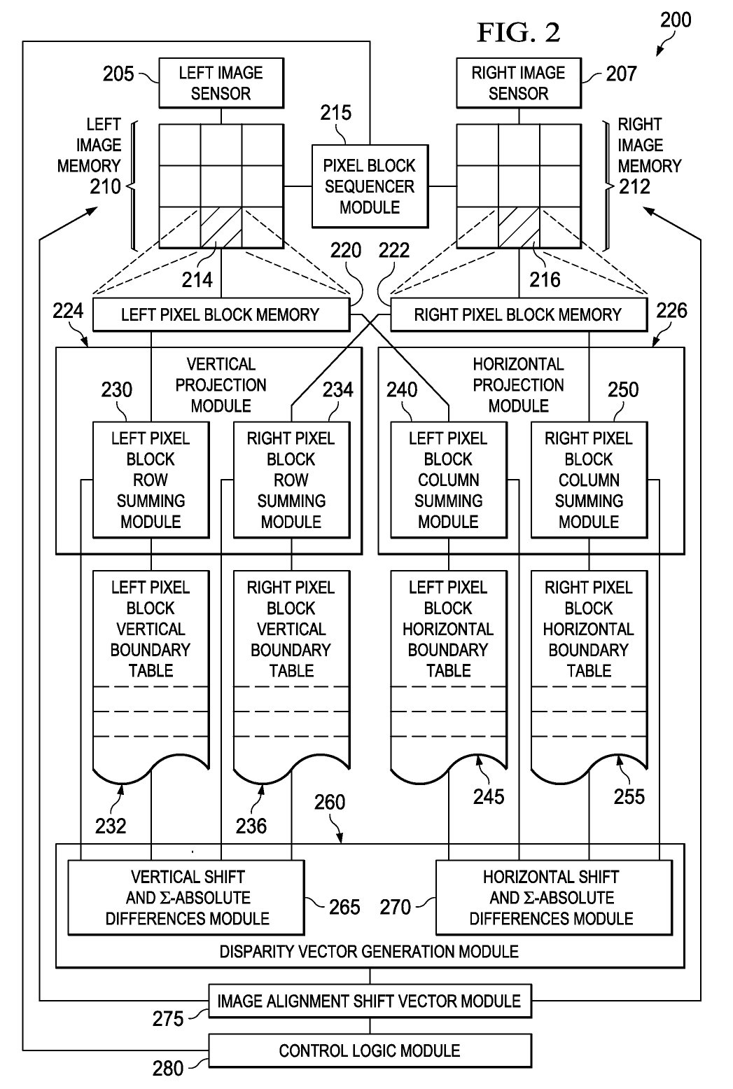

FIG. 2 is a block diagram of a stereoscopic image alignment system 200 according to various example embodiments. In some embodiments, the system 200 may include left and right image sensors 205 and 207, respectively. Other embodiments of the stereoscopic image alignment system 200 may operate on pre-existing stereoscopic images. The image sensors 205 and 207 create left and right images by capturing photons at pixel locations framed by the left and right image sensors 205 and 207. A pixel luminance value corresponding to photons captured at each pixel is generated.

Some embodiments of the system 200 may also includes left and right image memories 210 and 212 communicatively coupled to the left and right image sensors 205 and 207, respectively. The left and right image memories 210 and 212 store the pixel luminance values associated with the left and right images. It is noted, however, that some embodiments may be implemented to process the image data directly from the image sensors 205 and 207 without intermediate storage in image memories.

The system 200 may also include a pixel block sequencer module 215 communicatively coupled to the left and right image memories. In embodiments without intermediate pixel luminance value storage, the pixel block sequencer may be communicatively coupled directly to the image sensors 205 and 207. The pixel block sequencer module 215 selects the next left and right pixel blocks (e.g., the left and right pixel blocks 214 and 216, respectively) for processing. In some embodiments, left and right pixel block memories 220 and 222 may be communicatively coupled to the left and right image memories 210 and 212. The left and right pixel block memories 220 and 222 store pixel luminance values associated with the left and right pixel blocks 214 and 216, respectively.

The system 200 may further include a vertical projection module 224 communicatively coupled to the left and right pixel block memories 220 and 222, respectively. The vertical projection module 224 creates two one-dimensional weighted projections of rows of pixel luminance values, a vertical projection from the pixel block 214 selected from the left image and a vertical projection from the corresponding pixel block 216 selected from the right image.

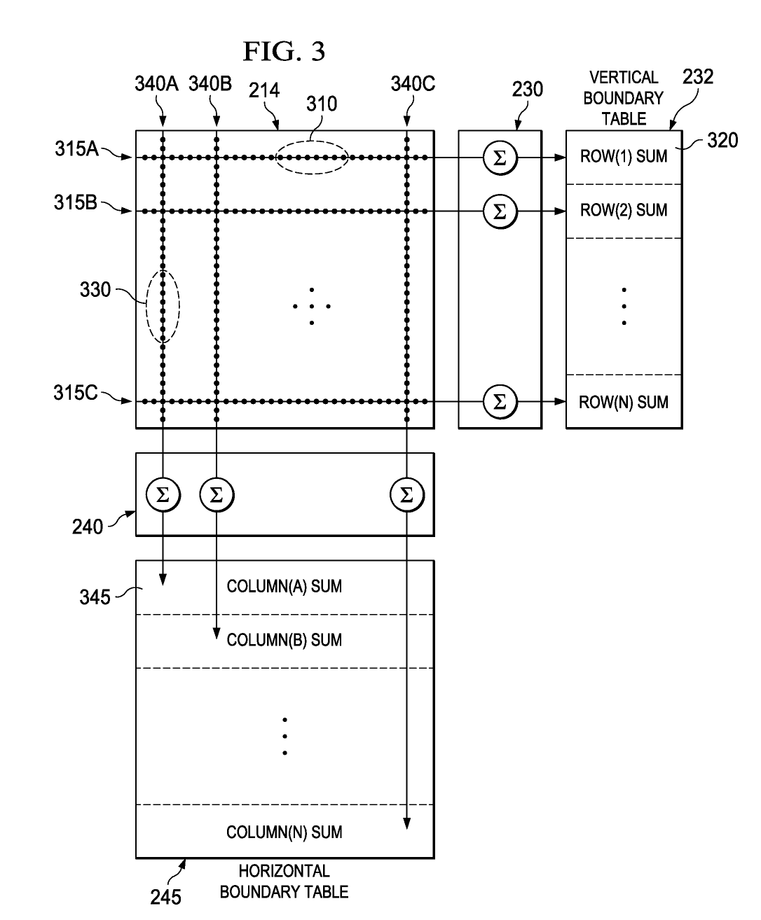

FIG. 3 is a schematic diagram illustrating an example pixel block (e.g., the left pixel block 214 or the right pixel block 216) and an associated boundary table creation mechanism. Referring to FIG. 2 and FIG. 3 together, the vertical projection module 224 may include a left pixel block row summing module 230 communicatively coupled to the left pixel block memory 220. The left pixel block row summing module 230 sums pixel luminance values (e.g., the luminance values associated with pixels 310) from each row of pixels (e.g., the pixel rows 315A, 315B, and 315C) associated with the left pixel block 214. Each sum is stored in a left pixel block vertical boundary table 232, one table entry for each row of pixels (e.g., the table entry 320 representing the sum associated with pixel row 315A).

Symmetrically to the structures described for the vertical projection associated with the left pixel block 214, a right pixel block row summing module 234 is communicatively coupled to the right pixel block memory 220. The right pixel block row summing module 234 sums pixel luminance values from each row of pixels associated with the right pixel block 216 for storage in a right pixel block vertical boundary table 236, one table entry for each row of pixels. (It is noted that, while the reference numerals of FIG. 3 refer solely to projections associated with the left image pixel block 214, the structures illustrated in FIG. 3 are otherwise equally applicable to projections associated with the right image pixel block 216.)

The system 200 may also include a horizontal projection module 226 communicatively coupled to the left and right pixel block memories 220 and 222. The horizontal projection module 226 creates two one-dimensional weighted projections of columns of pixel luminance values, a horizontal projection from the left pixel block 214 and a horizontal projection from the right pixel block 216.

Referring again to FIG. 2 and FIG. 3 together, the horizontal projection module 226 includes a left pixel block column summing module 240 communicatively coupled to the left pixel block memory 220. The left pixel block column summing module 240 sums pixel luminance values (e.g., the luminance values associated with pixels 330) from each column of pixels (e.g., the columns of pixels 340A, 340B, and 340C) associated with the left pixel block 214. Each sum is stored in a left pixel block horizontal boundary table 245, one table entry (e.g., the table entry 345) for each column of pixels (e.g., the column of pixels 340A).

Symmetrically to the structures described for the horizontal projection associated with the left pixel block 214, a right pixel block column summing module 250 is communicatively coupled to the right pixel block memory 222. The right pixel block column summing module 250 sums pixel luminance values from each column of pixels associated with the right pixel block 216 for storage in a right pixel block horizontal boundary table 255, one table entry for each column of pixels.

The stereoscopic image alignment system 200 also includes a disparity vector generation module 260 communicatively coupled to the vertical projection module 224 and to the horizontal projection module 226. The disparity vector generation module 260 shifts vertical projections from the left and right pixel blocks 214 and 216 with respect to each other. One or both of the vertical projections are shifted on a row by row basis to best align pixel luminance value aggregations along the vertical projections. A vertical row offset between the left and right vertical projections is tracked as the alignment operation proceeds. A vertical component of a pixel block disparity vector is set equal to the final vertical row offset.

FIG. 4 is a diagram illustrating left and right image block boundary table correlation according to various example embodiments. Referring to FIG. 2 together with FIG. 4, some embodiments of the stereoscopic image alignment system 200 may include a vertical shift and sum of absolute differences module 265 communicatively coupled to the left and right pixel block row summing modules 230 and 234. The vertical shift and sum of absolute differences module 265 determines the vertical boundary table shift index corresponding to the vertical row offset previously mentioned.

The vertical shift and sum of absolute differences module 265 finds a best-fit numerical correspondence between values in the left pixel block vertical boundary table 232 (e.g., the values 405A and 405B) and values in the right pixel block vertical boundary table 236 (e.g., the values 410A and 410B) at an offset equal to the vertical boundary table shift index value.

For each position in the left vertical boundary table 232 for which there exists a value at an aligned position in the right vertical boundary table 236, the module 265 calculates an absolute difference between the two values and then sums the resulting absolute differences. The module 265 then shifts all of the values in either the left vertical boundary table 232 or the right vertical boundary table 236 by a single position, repeats the absolute difference and summing operations, and stores a vertical boundary table shift index value equal to the shift iteration index. The vertical shift index corresponds to the positional offset between the left and right vertical boundary tables 232 and 236. This process repeats until a sum of absolute differences has been calculated at each table alignment position for which both a left vertical boundary table value and a right vertical boundary table value are available.

The vertical shift and sum of absolute differences module 265 then chooses the vertical boundary table shift index corresponding to the smallest calculated sum of absolute differences (e.g., the vertical shift index 425 of FIG. 4) as the vertical component of a disparity vector representing the disparity between the pixel blocks 214 and 216.

The disparity vector generation module 260 also shifts horizontal projections from the left and right pixel blocks 214 and 216 with respect to each other to best align pixel luminance value aggregations along the horizontal projections of the left and right pixel blocks 214 and 216. These operations yield a horizontal component of the pixel block disparity vector.

Some embodiments of the stereoscopic image alignment system 200 may also include a vertical shift and sum of absolute differences module 270 communicatively coupled to the left and right pixel block column summing modules 240 and 250. The vertical shift and sum of absolute differences module 270 performs an example method of determining a horizontal boundary table shift index value analogous to the procedure previously described for determining the vertical boundary table shift index.

The horizontal shift and sum of absolute differences module 270 finds a best-fit numerical correspondence between values in the left pixel block horizontal boundary table 245 and the values in the right pixel block horizontal boundary table 255 at an offset equal to the horizontal boundary table shift index value.

For each position in the left horizontal boundary table 245 for which there exists a value at an aligned position in the right horizontal boundary table 255, the module 270 calculates an absolute difference between the two values and then sums the resulting absolute differences. The module 270 then shifts all of the values in either the left horizontal boundary table 245 or the right horizontal boundary table 255 by a single position, repeats the absolute difference and summing operations, and stores a horizontal boundary table shift index value corresponding to the shift iteration index. The horizontal shift index corresponds to the positional offset between the left and right horizontal boundary tables 245 and 255. This process repeats until a sum of absolute differences has been calculated at each table alignment position for which both a left horizontal boundary table value and a right horizontal boundary table value are available.

The horizontal shift and sum of absolute differences module 270 then chooses the horizontal boundary table shift index corresponding to the smallest calculated sum of absolute differences as the horizontal component of the disparity vector representing the disparity between the pixel blocks 214 and 216.

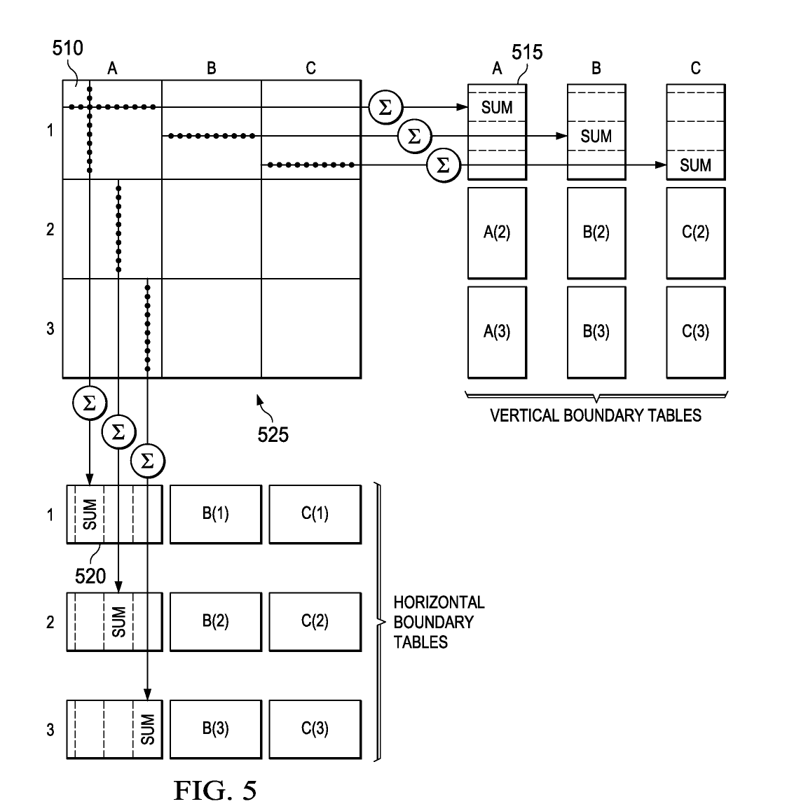

FIG. 5 is a schematic diagram illustrating multiple pixel blocks (e.g., the pixel block 510) and corresponding vertical and horizontal boundary tables (e.g., the vertical boundary table 515 and the horizontal boundary table 520) associated with an example image frame 525 according to various example embodiments. Although nine pixel blocks are shown in the example image frame 525, it is noted that various embodiments may be implemented with various numbers of pixel blocks, including a single pixel block for the entire frame 525.

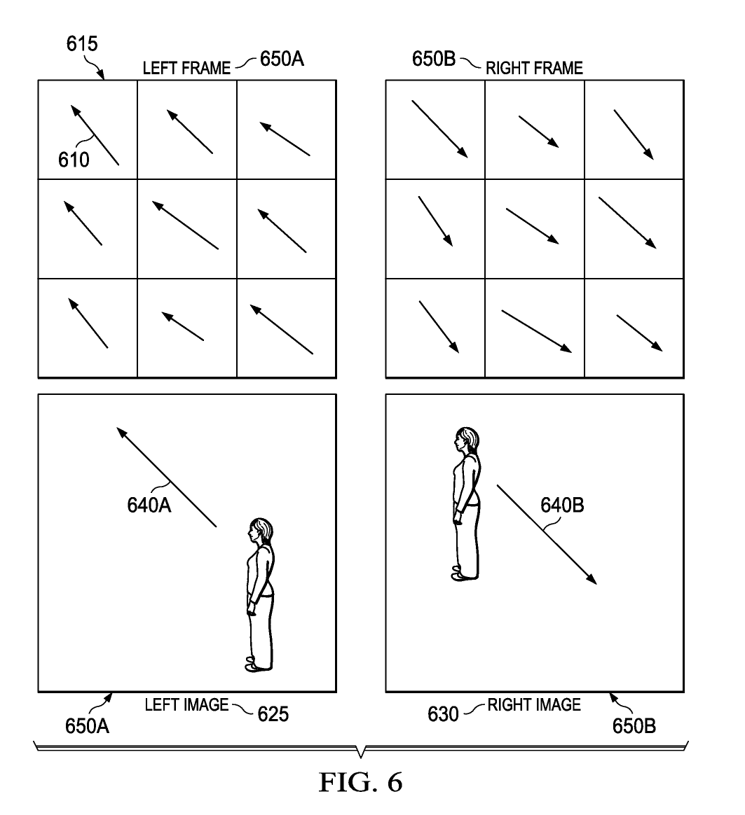

FIG. 6 is a schematic diagram showing image block disparity vectors (e.g., the disparity vector 610) and image alignment within left and right image frames 650A and 650B according to various example embodiments. Referring to FIG. 2 and FIG. 6 together, the stereoscopic image alignment system 200 may further include an image alignment shift vector module 275 communicatively coupled to the disparity vector generation module 260. The image alignment shift vector module 275 algebraically combines disparity vectors (e.g., the disparity vector 610) derived from corresponding pixel blocks (e.g., the pixel block 615) selected from left and right images 625 and 630 to generate image alignment shift vectors 640A and 640B.

Some embodiments may shift either the left image 625 or the right image 630 within the image frame 650A or 650B according to the corresponding image alignment shift vector 640A or 640B. Some embodiments may, on the other hand, shift both the left image 625 and the right image 630 within the frames 650A and 650B by one half of the magnitude of the image alignment shift vector 640A, 640B, in opposite directions, in order to maintain an average position of the left image 625 and the right image 630 relative to the image frames 650A and 650B.

Referring back to FIG. 2, the stereoscopic image alignment system 200 also includes a control logic module 280 communicatively coupled to the image alignment shift vector module 275 and to the pixel block sequencer module 215. The control logic module 280 establishes and maintains cycles of image alignment processing and sub-cycles of pixel block disparity vector processing associated with each pixel block and each stereoscopic image pair.

The image frames 101, 103, 525, 650A, 650B; the pixel blocks 105, 110, 214, 216, 510, 615; the system 200; the image sensors 205, 207; the memories 210, 212, 220, 222; the sequencer module 215; the projection modules 224, 226; the summing modules 230, 234, 240, 250; the pixels 310, 330; the pixel rows 315A, 315B, 315C; the boundary tables 232, 236, 245, 255, 515, 520; the table entries 320, 345, 405A, 405B; 410A, 410B; the pixel columns 340A, 340B, 340C; the disparity vector generation module 260; the shift and sum of absolute differences modules 265, 270; the vertical shift index 425; the disparity vector 610; the image alignment shift vector module 275; the images 625, 630; the shift vectors 640A, 640B; and the control logic module 280 may all be characterized as “modules” herein.

The modules may include hardware circuitry, optical components, single or multi-processor circuits, memory circuits, and/or computer-readable media with computer instructions encoded therein/thereon capable of being executed by a processor (excluding non-functional descriptive matter), firmware and combinations thereof, as desired by the architects of the system 200 and as appropriate for particular implementations of various embodiments.

The apparatus and systems described herein may be useful in applications other than producing an image alignment shift vector to be used to shift left and right image portions of a stereoscopic image with respect to each other in order to reduce or eliminate horizontal and vertical disparity. Examples of the system 200 described herein are intended to provide a general understanding of the structures of various embodiments. They are not intended to serve as a complete description of all elements and features of apparatus and systems that might make use of these structures.

The various embodiments may be incorporated into electronic circuitry used in computers, communication and signal processing circuitry, single-processor or multi-processor modules, single or multiple embedded processors, multi-core processors, data switches, and application-specific modules including multi-layer, multi-chip modules, among others. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., MP3 (Motion Picture Experts Group, Audio Layer 3) players), vehicles, medical devices (e.g., heart monitor, blood pressure monitor, etc.), set top boxes, and others. Some embodiments may also include one or more methods.

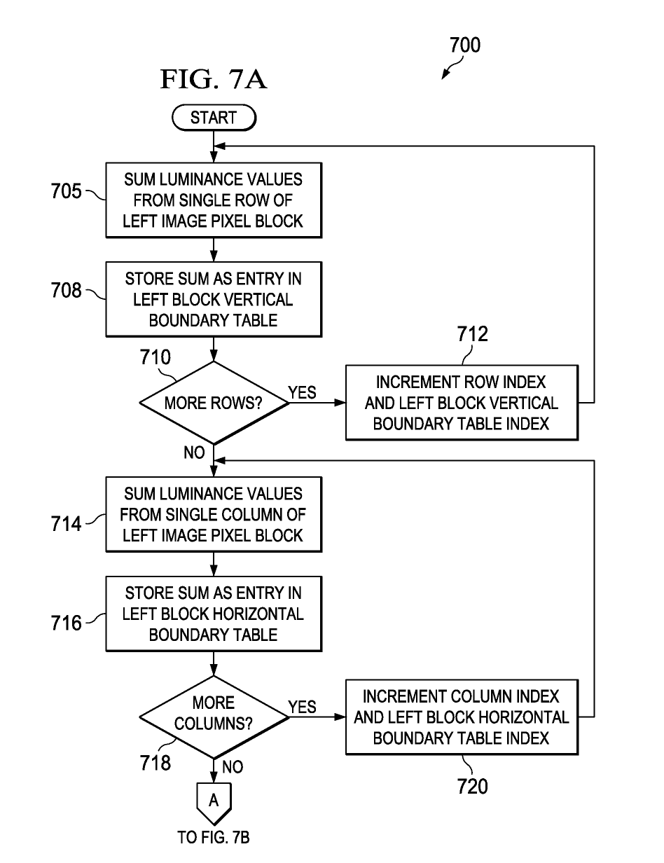

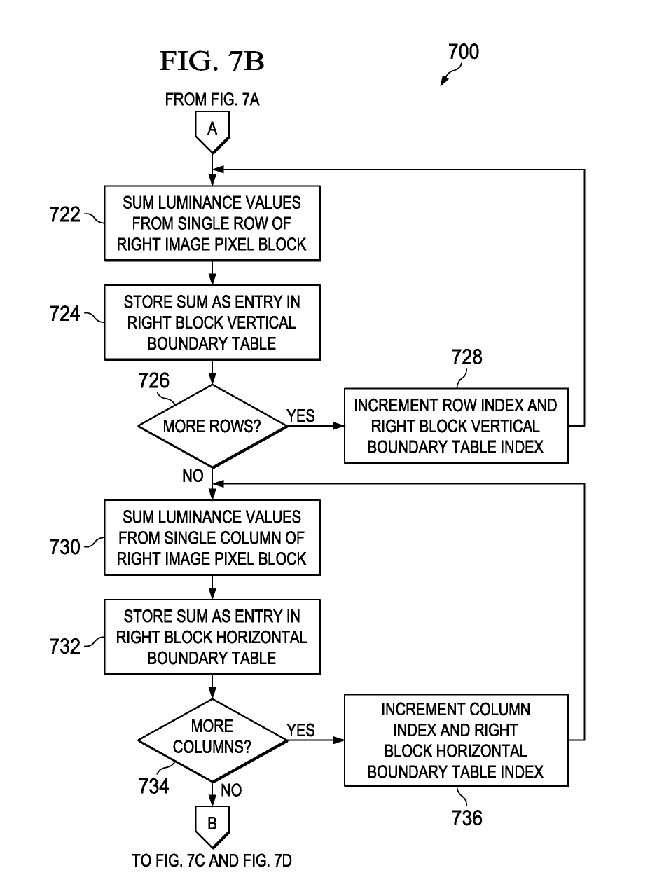

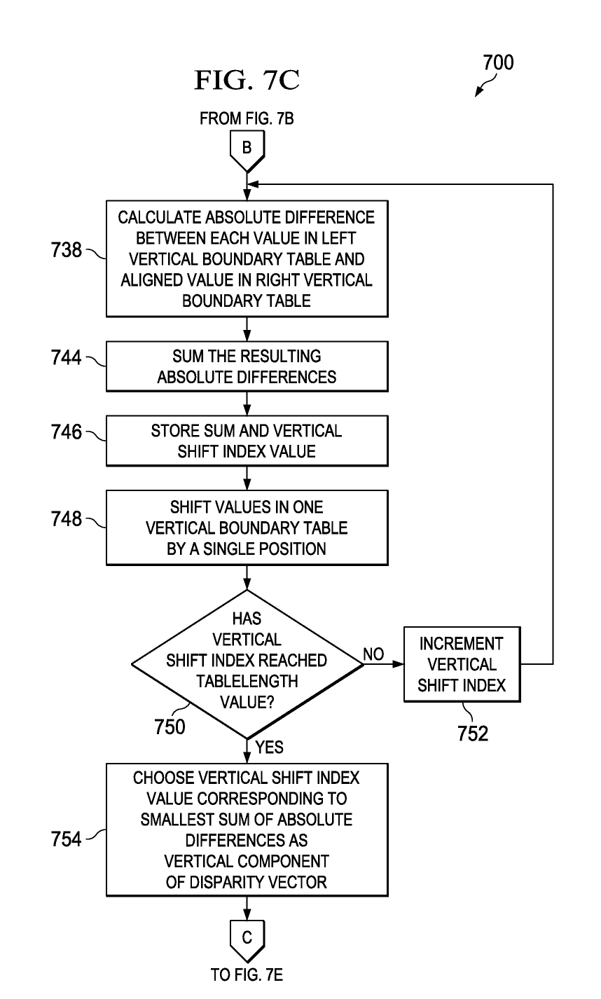

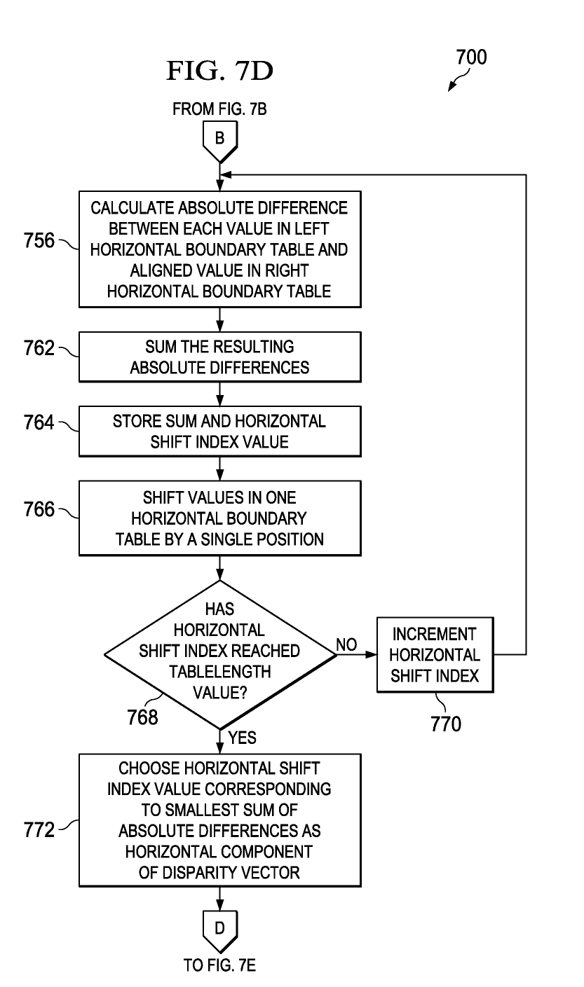

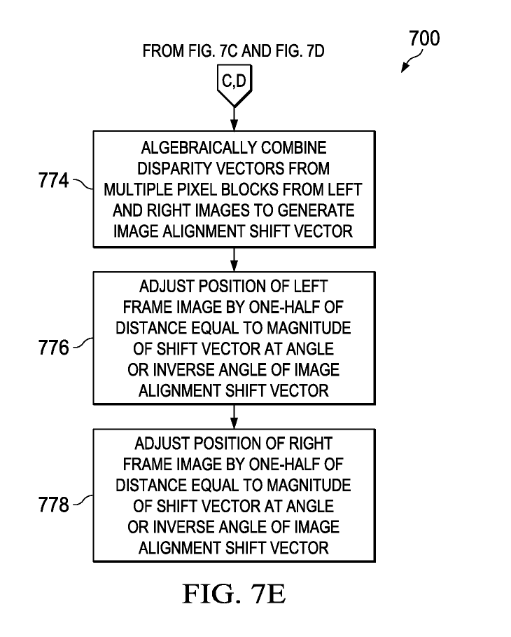

FIGS. 7A, 7B, 7C, 7D and 7E are flow diagrams illustrating several example methods according to the invention. A method 700 operates to produce an image alignment shift vector used to shift left and right image portions of a stereoscopic image with respect to each other in order to reduce or eliminate horizontal and vertical disparity.

The method 700 includes creating a vertical axis projection and a horizontal axis projection of a pixel block selected from the left image and a corresponding pixel block selected from the right image. In some versions of the method 700, the vertical axis projections are created by aggregating rows of pixel luminance values from the left and right image blocks into left and right single-dimension vertical boundary tables. Likewise, the horizontal axis projections are created by aggregating columns of pixel luminance values from the left and right image blocks into left and right single dimension horizontal boundary tables.

The method 700 also includes correlating the luminance value aggregations along the left pixel block vertical axis projection to luminance value aggregations along the right pixel block vertical axis projection to determine a vertical offset between the pixel blocks from the left and right images. Likewise, the method 700 includes correlating the luminance value aggregations along the left pixel block horizontal axis projection to the luminance value aggregations along the right pixel block horizontal axis projection to determine a horizontal offset between the left and right image pixel blocks. In some versions of the method 700, correlation operations may align left and right vertical and horizontal boundary tables by matching left and right boundary table entries on a best-fit basis. The resulting table offsets correspond to vertical and horizontal components of a disparity vector corresponding to the selected block of pixels.

The method 700 further includes shifting the left image, the right image, or both vertically and horizontally in amounts proportional to the vertical and horizontal offset, respectively. Some versions of the method 700 may include adjusting image positions within left and right image frames, respectively, by a distance proportional to the magnitude of the disparity vector. The images are adjusted in a direction corresponding to the angle of the disparity vector or to an angle inverse to that of the disparity vector.

The method 700 may include summing pixel luminance values from each row of pixels associated with the left and right image pixel block. These summing operations generate entries in the left and right pixel block vertical boundary tables, respectively, one table entry for each row of pixels. Accordingly, the method 700 may commence at block 705 with summing pixel luminance values from a row of pixels from the left image pixel block. The method 700 may continue at block 708 with storing the resulting sum in the left block vertical boundary table. The method may also include determining whether there are additional rows of pixels to be summed, at block 710. If so, the method 700 may include incrementing a row index and a left block vertical boundary table index, at block 712, and performing another iteration beginning at block 705.

The method 700 may proceed at block 714 with summing pixel luminance values from a row of pixels from the right image pixel block. The method 700 may continue at block 716 with storing the resulting sum in the right block vertical boundary table. The method may also include determining whether there are additional rows of pixels to be summed, at block 718. If so, the method 700 may include incrementing a row index and a right block vertical boundary table index, at block 720, and performing another iteration beginning at block 714.

The method 700 may also include summing pixel luminance values from each column of pixels associated with the left and right image pixel blocks. These summing operations generate entries in the left and right pixel block horizontal boundary tables, respectively, one table entry for each column of pixels. Accordingly, the method 700 may commence at block 722 with summing pixel luminance values from a column of pixels from the left image pixel block. The method 700 may continue at block 724 with storing the resulting sum in the left block horizontal boundary table. The method may also include determining whether there are additional columns of pixels to be summed, at block 726. If so, the method 700 may include incrementing a column index and a left block horizontal boundary table index, at block 728, and performing another iteration beginning at block 722.

The method 700 may proceed at block 730 with summing pixel luminance values from a column of pixels from the right image pixel block. The method 700 may continue at block 732 with storing the resulting sum in the right block horizontal boundary table. The method may also include determining whether there are additional columns of pixels to be summed, at block 734. If so, the method 700 may include incrementing a column index and a right block horizontal boundary table index, at block 736, and performing another iteration beginning at block 730.

The method 700 may also include determining vertical and horizontal boundary table shift indices associated with best-fit numerical correspondences between left and right vertical boundary tables and between left and right horizontal boundary tables, respectively. The vertical and horizontal components of the pixel block disparity vector are set equal to the vertical and horizontal boundary table shift indices corresponding to the best vertical and horizontal fits, respectively.

The method 700 may thus proceed at block 738 with calculating, for each position in the left vertical boundary table for which there exists a value at an aligned position in the right vertical boundary table, the absolute difference between the two values. The method 700 may continue at block 744 with summing the absolute differences resulting from the operations performed at block 738. The method 700 may also include storing the resulting sum of the absolute differences and a vertical shift index value corresponding to the number of iterations of the activities associated with blocks 738 and 744, at block 746.

The method 700 may proceed at block 748 with shifting the values in either the left or right vertical boundary table by a single position. The method 700 may include determining whether the vertical shift index has reached a preset table length value, at block 750. If not, the method 700 may include incrementing the vertical shift index, at block 752, and returning to block 738. From block 738, the method 700 performs another iteration of calculating the absolute differences, summing the resulting absolute differences, and shifting the tables with respect to each other. The method 700 further includes choosing the vertical shift index value corresponding to the smallest sum of absolute differences obtained from the iterations of the activities associated with blocks 738 through 748 as the vertical component of the pixel block disparity vector, at block 754.

The horizontal component of the pixel block disparity vector may be determined in a symmetrical manner. The method 700 may thus continue at block 756 with calculating, for each position in the left horizontal boundary table for which there exists a value at an aligned position in the right horizontal boundary table, the absolute difference between the two values. The method 700 may proceed at block 762 with summing the absolute differences resulting from the operations performed at block 756. The method 700 may also include storing the resulting sum of the absolute differences and a horizontal shift index value corresponding to the number of iterations of the activities associated with blocks 756 and 762, at block 764.

The method 700 may proceed at block 766 with shifting the values in either the left or right horizontal boundary table by a single position. The method 700 may include determining whether the horizontal shift index has reached a preset table length value, at block 768. If not, the method 700 may include incrementing the horizontal shift index, at block 770, and returning to block 756. From block 756, the method 700 performs another iteration of calculating the absolute differences, summing the resulting absolute differences, and shifting the horizontal boundary tables with respect to each other. The method 700 further includes choosing the horizontal shift index value corresponding to the smallest sum of absolute differences obtained from the iterations of the activities associated with blocks 756 through 766 as the vertical component of the pixel block disparity vector, at block 772.

Some versions of the method 700 may operate on multiple pixel blocks selected from each of the left and right image frames associated with the stereoscopic image. The method 700 may therefore proceed at block 774 with algebraically combining multiple disparity vectors, one disparity vector associated with each left/right pair of pixel blocks, to create an image alignment shift vector. Some versions of the method 700 may combine the disparity vectors by averaging their magnitudes and angles, for example. It is noted, however, that other algebraic combinations of the disparity vectors are contemplated in this disclosure. Some versions of the method 700 may, for example, assign different weights to each disparity vector or two groups of disparity vectors.

The method 700 may also include adjusting the image position associated with the left image frame by one-half of the distance equal to the magnitude of the image alignment shift vector, at block 776. The left image may be shifted in the direction of the angle of the image alignment shift vector or at an angle inverse to the angle of the image alignment shift vector such as to move the left image into closer alignment with the right image.

The method 700 may conclude at block 778 with adjusting the image position associated with the right image frame by one-half of the distance equal to the magnitude of the image alignment shift vector. The right image may be shifted in the direction of the angle of the image alignment shift vector or at an angle inverse to the angle of the image alignment shift vector such as to move the right image into closer alignment with the left image.

It is noted that the activities described herein may be executed in an order other than the order described. The various activities described with respect to the methods identified herein may also be executed in repetitive, serial, and/or parallel fashion. In some embodiments, for example, the method 700 may repeat in whole or in part according to the resolution of the stereoscopic image and according to the number of pixel blocks into which the stereoscopic image is divided.

Apparatus, systems, and methods described herein operate to generate an image alignment shift vector used to shift left and right image portions of a stereoscopic image with respect to each other in order to reduce or eliminate undesirable horizontal and vertical disparity components. Processing power is conserved by correlating vertical and horizontal projections of pixel luminance values to derive vertical and horizontal components of the image alignment shift vector in contrast to performing image identification on an entire pixel matrix.

By way of illustration and not of limitation, the accompanying figures show specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense. The breadth of various embodiments is defined by the appended claims and the full range of equivalents to which such claims are entitled.

Such embodiments of the inventive subject matter may be referred to herein individually or collectively by the term “invention” merely for convenience and without intending to voluntarily limit this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments.

The Abstract of the Disclosure is provided to comply with 37 C.F.R. §1.72(b) requiring an abstract that will allow the reader to quickly ascertain the nature of the technical disclosure. It is submitted with the understanding that it will not be used to interpret or limit the scope or meaning of the claims. In the preceding Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. The following claims are hereby incorporated into the Detailed Description, with each claim standing on its own as a separate embodiment.

What is claimed is:

1. A stereoscopic image alignment system, comprising:
a vertical projection module to create two one-dimensional weighted projections of rows of pixel luminance values, a vertical projection from a block of pixels selected from a left image associated with a stereoscopic image and a vertical projection from a corresponding block of pixels selected from a right image associated with the stereoscopic image;
a horizontal projection module to create two one-dimensional weighted projections of columns of pixel luminance values, one horizontal projection from the block of pixels selected from the left image and one horizontal projection from the block of pixels selected from the right image;
a disparity vector generation module communicatively coupled to the vertical projection module and to the horizontal projection module to shift the vertical projections from the left and right pixel blocks with respect to each other to best align pixel luminance value aggregations along the vertical projections, a vertical component of a pixel block disparity vector corresponding to a number of pixel rows shifted; and to shift the horizontal projections from the left and right pixel blocks with respect to each other to best align pixel luminance value aggregations along the horizontal projections, a horizontal component of the pixel block disparity vector corresponding to a number of pixel columns shifted; and
an image alignment shift vector module communicatively coupled to the disparity vector generation module to algebraically combine disparity vectors derived from multiple pixel blocks selected from the left and right images to generate an image alignment shift vector.

2. The stereoscopic image alignment system of claim 1, further comprising:
left and right image sensors to create left and right images by capturing photons at pixel locations framed by the left and right image sensors and to generate a pixel luminance value corresponding to photons captured at each pixel; and
left and right image memories communicatively coupled to the left and right image sensors to store the pixel luminance values associated with the left and right images.

3. The stereoscopic image alignment system of claim 2, further comprising:
a pixel block sequencer module communicatively coupled to the left and right image memories to select next left and right pixel blocks for processing; and
left and right pixel block memories communicatively coupled to the left and right image memories to store pixel luminance values associated with the next left and right pixel blocks.

4. The stereoscopic image alignment system of claim 3, the disparity vector generation module further comprising:
a control logic module communicatively coupled to the image alignment shift vector module and to the pixel block sequencer module to control cycles of image alignment processing and sub cycles of pixel block disparity vector processing.

5. The stereoscopic image alignment system of claim 3, the vertical projection module further comprising:
a left pixel block row summing module communicatively coupled to the left pixel block memory to sum pixel luminance values from each row of pixels associated with the left pixel block for storage in a left pixel block vertical boundary table, one table entry for each row of pixels; and
a right pixel block row summing module communicatively coupled to the right pixel block memory to sum pixel luminance values from each row of pixels associated with the right pixel block for storage in a right pixel block vertical boundary table, one table entry for each row of pixels

6. The stereoscopic image alignment system of claim 5, the disparity vector generation module further comprising:
a vertical shift and sum of absolute differences module communicatively coupled to the left and right pixel block row summing modules to determine a vertical boundary table shift index value associated with a best-fit numerical correspondence between the values in the left pixel block vertical boundary table and the values in the right pixel block vertical boundary table at corresponding positions within the tables by calculating, for each position in the left vertical boundary table for which there exists a value at an aligned position in the right vertical boundary table, an absolute difference between the two values; summing the resulting absolute differences; shifting the values in either the left vertical boundary table or the right vertical boundary table by a single position;
repeating the absolute difference calculations, the summing of the resulting absolute differences, and the shifting operations at each table position for which both a left vertical boundary table value and a right vertical boundary table value are available; and
choosing a number of shift positions corresponding to a smallest resulting sum of absolute differences as the vertical boundary table shift index value and as the vertical component of the disparity vector.

7. The stereoscopic image alignment system of claim 3, the horizontal projection module further comprising:
a left pixel block column summing module communicatively coupled to the left pixel block memory to sum pixel luminance values from each column of pixels associated with the left pixel block for storage in a left pixel block horizontal boundary table, one table entry for each column of pixels; and
a right pixel block column summing module communicatively coupled to the right pixel block memory to sum pixel luminance values from each column of pixels associated with the right pixel block for storage in a right pixel block horizontal boundary table, one table entry for each column of pixels.

8. The stereoscopic image alignment system of claim 7, the disparity vector generation module further comprising:
a horizontal shift and a sum of absolute differences module communicatively coupled to the left and right pixel block column summing modules to determine a horizontal boundary table shift index value associated with a best-fit numerical correspondence between the values in the left pixel block horizontal boundary table and the values in the right pixel block horizontal boundary table at corresponding positions within the tables by calculating, for each position in the left horizontal boundary table for which there exists a value at an aligned position in the right horizontal boundary table, an absolute difference between the two values; summing the resulting absolute differences; shifting the values in either the left pixel block horizontal boundary table or the right pixel block horizontal boundary table by a single position; repeating the absolute difference calculations, the summing of the resulting absolute differences, and the shifting operations at each table position for which both a left pixel block horizontal boundary table value and a right pixel block horizontal boundary table value are available; and choosing a number of shift positions corresponding to a smallest resulting sum of absolute differences as the horizontal boundary table shift index value and as the horizontal component of the disparity vector.

9. A method of stereoscopic image pair alignment, comprising:
for each of a left image and a right image associated with a stereoscopic image, creating two one-dimensional weighted projections of luminance values for each of at least one pixel block, one projection along each of a vertical axis and a horizontal axis associated with the pixel block from the left image and one projection along each of a vertical axis and a horizontal axis associated with the pixel block from the right image;
correlating luminance value aggregations along the left pixel block vertical axis projection to luminance value aggregations along the right pixel block vertical axis projection to determine a vertical offset between the pixel blocks from the left and right images;
correlating luminance value aggregations along the left pixel block vertical axis projection to luminance value aggregations along the right pixel block vertical axis projection to determine a horizontal offset between the pixel blocks from the left and right images;
shifting at least one of the left image or the right image vertically in an amount proportional to the vertical offset and horizontally in an amount proportional to the horizontal offset.

10. The method of stereoscopic image pair alignment of claim 9, further comprising:
converting the at least one block of pixel luminance values from the left image into two single-dimension boundary tables including a left pixel block vertical boundary table and a left pixel block horizontal boundary table;
converting the at least one block of pixel luminance values from the right image into two single-dimension pixel block boundary tables including a right pixel block vertical boundary table and a right pixel block horizontal boundary table;
performing correlation operations on entries in the left and right pixel block vertical boundary tables to determine a magnitude of a vertical component of a disparity vector corresponding to the pixel blocks from the left and right images;
performing correlation operations on entries in the left and right pixel block horizontal boundary tables to determine a magnitude of a horizontal component of the disparity vector corresponding to the pixel blocks from the left and right images;
adjusting an image position within an image frame associated with at least one of the left image or the right image by a distance proportional to a magnitude of the disparity vector at an angle corresponding to the disparity vector or at an angle inverse to that of the disparity vector.

11. The method of stereoscopic image pair alignment of claim 10, further comprising:
summing pixel luminance values from each row of pixels associated with the pixel block from the left image to generate the entries in the left pixel block vertical boundary table, one table entry for each row of pixels; and
summing pixel luminance values from each column of pixels associated with the pixel block from the left image to generate the entries in the left pixel block horizontal boundary table, one table entry for each column of pixels.

12. The method of stereoscopic image pair alignment of claim 10, further comprising:
summing pixel luminance values from each row of pixels associated with the pixel block from the right image to generate the entries in the right pixel block vertical boundary table, one table entry for each row of pixels; and
summing pixel luminance values from each column of pixels associated with the pixel block from the right image to generate the entries in the right pixel block horizontal boundary table, one table entry for each column of pixels.

13. The method of stereoscopic image pair alignment of claim 10, the correlation operations further comprising:
determining a vertical boundary table shift index value associated with a best-fit numerical correspondence between the values in the left pixel block vertical boundary table and the values in the right pixel block vertical boundary table at corresponding positions within the tables; and
setting a magnitude of the vertical component of the disparity vector equal to the vertical boundary table shift index value.

14. The method of stereoscopic image pair alignment of claim 13, the correlation operations further comprising:
for each position in the left vertical boundary table for which there exists a value at an aligned position in the right vertical boundary table, calculating an absolute difference between the two values;
summing the resulting absolute differences;
shifting the values in either the left vertical boundary table or the right vertical boundary table by a single position;
repeating the absolute difference calculations, the summing of the resulting absolute differences, and the shifting operations at each table position for which both a left vertical boundary table value and a right vertical boundary table value are available; and
choosing a vertical boundary table shift index value corresponding to a smallest resulting sum of absolute differences as the vertical component of the disparity vector.

15. The method of stereoscopic image pair alignment of claim 10, the correlation operations further comprising:
determining a horizontal boundary table shift index associated with a best-fit numerical correspondence between the values in the left pixel block horizontal boundary table and the values in the right pixel block horizontal boundary table at corresponding positions within the tables; and
setting a magnitude of the horizontal component of the disparity vector equal to the horizontal boundary table shift index value.

16. The method of stereoscopic image pair alignment of claim 15, the correlation operations further comprising:
for each position in the left horizontal boundary table for which there exists a value at an aligned position in the right horizontal boundary table, calculating an absolute difference between the two values;
summing the resulting absolute differences;
shifting the values in either the left pixel block horizontal boundary table or the right pixel block horizontal boundary table by a single position;
repeating the absolute difference calculations, the summing of the resulting absolute differences, and the shifting operations at each table position for which both a left pixel block horizontal boundary table value and a right pixel block horizontal boundary table value are available; and
choosing a horizontal boundary table shift index corresponding to a smallest resulting sum of absolute differences as the horizontal component of the disparity vector.

17. The method of stereoscopic image pair alignment of claim 10, further comprising:
algebraically combining multiple disparity vectors, one disparity vector associated with each of multiple blocks of pixel luminance values selected from the left and right images to create an image alignment shift vector.

18. The method of stereoscopic image pair alignment of claim 17, further comprising:
averaging magnitudes and angles associated with the multiple disparity vectors to calculate the algebraic combination.

19. The method of stereoscopic image pair alignment of claim 17, further comprising:
adjusting the image position associated with the left image frame by one-half of a distance equal to a magnitude of the image alignment shift vector at either an angle of the image alignment shift vector or at an angle inverse to the angle of the image alignment shift vector such as to move the left image into closer alignment with the right image; and
adjusting the image position associated with the right image frame by one-half of the distance equal to the magnitude of the image alignment shift vector at either the angle of the image alignment shift vector or at the angle inverse to the angle of the image alignment shift vector such as to move the right image into closer alignment with the left image.

20. A method of stereoscopic image pair alignment, comprising:
summing pixel luminance values from each row of pixels associated with pixel blocks from a left image and a right image to obtain entries in a left and right pixel block vertical boundary tables, one entry in each table for each row of pixels;
summing pixel luminance values from each column of pixels associated with the pixel blocks from the left and right images to obtain entries in left and right pixel block horizontal boundary tables, one entry in each table for each column of pixels;
performing correlation operations on entries in the left and right pixel block vertical boundary tables to determine a magnitude of a vertical component of a disparity vector corresponding to the pixel blocks from the left and right images;
performing correlation operations on entries in the left and right pixel block horizontal boundary tables to determine a magnitude of a horizontal component of a disparity vector corresponding to the pixel blocks from the left and right images;
algebraically combining multiple disparity vectors associated with multiple blocks of pixel luminance values selected from the left and right images to generate an image alignment shift vector;
adjusting the image position associated with the left image frame by one-half of the distance proportional to the magnitude of the image alignment shift vector at either the angle of the image alignment shift vector or at an angle inverse to the angle of the image alignment shift vector such as to move the left image into closer alignment with the right image; and
adjusting the image position associated with the right image frame by one-half of the distance proportional to the magnitude of the image alignment shift vector at either the angle of the image alignment shift vector or at an angle inverse to the angle of the image alignment shift vector such as to move the right image into closer alignment with the left image.
